(19) United States
(12) Patent Application Publication
(10) Pub. No.: US 2009/0108587 A1
(43) Pub. Date: Apr. 30, 2009

(54) Hybrid vertical axis wind turbine

(76) Inventor: Jason Matthew Mitmesser, Jeffersonville, IN (US)

Correspondence Address: Jason Mitmesser, 1512 E. 10th St. #55, Jeffersonville, IN, 47130, US

(21) Appl. No.: 12/217,955

(22) Filed: Jul. 10, 2008

Related U.S. Application Data
(60) Provisional application No. 60/958,998, filed on Jul. 10, 2007.

(51) Int. Cl. F03D 9/00; H02K 53/00

(52) U.S. Cl. 290/55; 415/916

(57) ABSTRACT

One embodiment of a hybrid vertical axis wind turbine with a big annular generator (40) electric motor auxiliary prime movers (42) and horizontal rotating steam turbine generators (106). The preferred embodiment has at least 5 wind turbines under an arch. The alternative embodiment has at least 3 wind turbines under an arch. Both embodiments also have steam turbine generators with a gear as an additional generator and prime mover of the big annular generator. Both embodiments contain double tapered spokes(54) connecting the wind turbine central axis tower to the big annular generators. Both embodiments have a blade control system (162, 142, 144).

### CROSS REFERENCE TO RELATED APPLICATIONS

This application claims the benefits of 60/958,998 filed Jul. 10, 2007 by the present inventor. Application number assigned to this application: Ser. No. 12/217,955

### FEDERALLY SPONSORED RESEARCH

Not Applicable

### SEQUENCE LISTING OR PROGRAM

Not Applicable

### BACKGROUND

1. Field of Invention

This invention relates to wind turbines, vertical axis wind turbines, and horizontal rotating steam turbine electric generators.

2. Prior Art

U.S. Pat. No. 5,525,037 John Cummings, U.S. Pat. No. 6,853,096 Young-Sil Yu and Byung-Soo Yu, and U.S. Pat. No. 7,077,628 Robert J. Acord.

One disadvantage of U.S. Pat. No. 6,853,096 is that its blades are comprised of vertical axis rotating wind catching panels, rendering the wind catching panels extremely difficult to control, as vertical axis wind catching panels would have to continuously rotate to a position of staying out of the wind on one half of a wind turbine rotation. This, while not impossible, would require complex computer programming that might make the wind turbine too expensive to operate. Also, this wind turbine cannot operate in light winds, as it has no prime mover other than the wind. This same disadvantage of a single prime mover, the wind, also applies to U.S. Pat. No. 5,525,037.

Standard horizontal axis propeller wind turbines have three big disadvantages; one that they cannot produce any power when winds are light, secondly, they shut down when the wind is very strong. Third, the windswept surface area size of these wind turbines, even if build to the current world's largest size of over 600 feet tall, combined with manufacturing speed equals not a very big solution for America's massive energy problem any time soon, and if it were a solution, it would require millions of these wind turbines to be placed all across America, which is unsightly, and requires large amounts of very expensive new power lines to be built. This reveals problems the present hybrid vertical axis wind turbine overcomes.

Standard horizontal axis steam turbine generators produce nearly all society's electricity throughout the world. These typical generators alone cannot feasibly power large amounts of other upcoming groundbreaking things. New Inventions that need fuel are electric cars powered by rapid charge batteries of Altair Nanotechnologies and a 363 miles per hour (Chicago to Orlando in 2.75 hours) mag lev trains requiring large amounts of electricity. Standard horizontal axis steam turbine generators alone are inadequate for the future if society wants to have the cheapest electricity.

### SUMMARY

In accordance with one embodiment a hybrid vertical axis wind turbine with a big annular generator with at least one electric motor auxiliary prime mover.

### DRAWINGS

### Figures

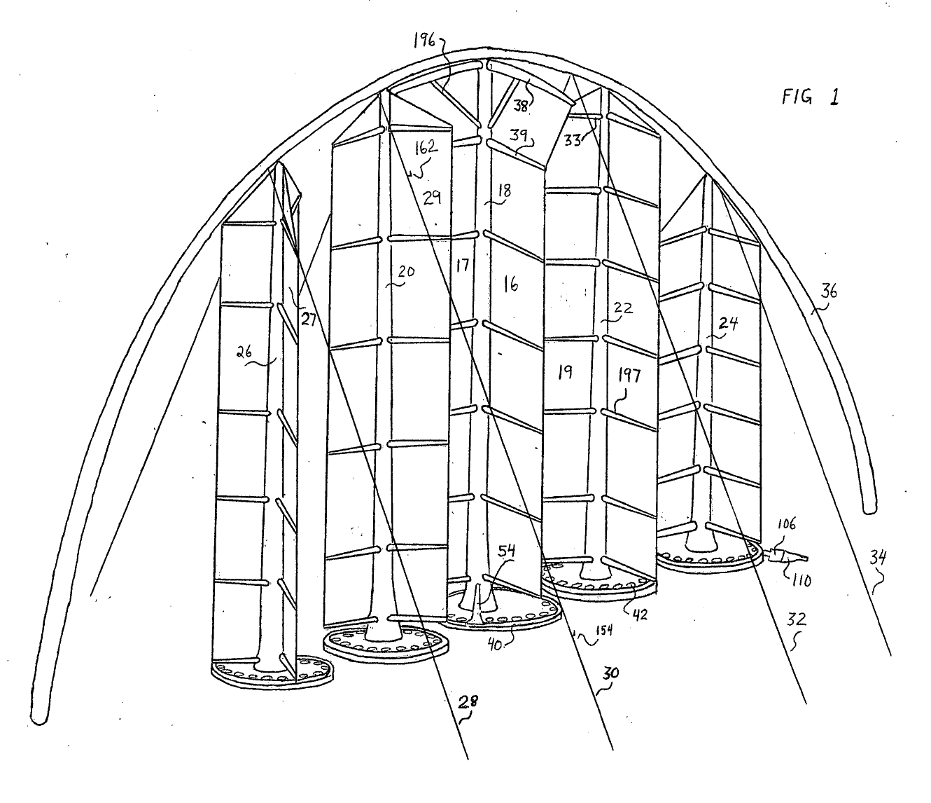

FIG. 1 shows the entire wind turbine, with one possible arrangement of 5 wind turbines under one arch.

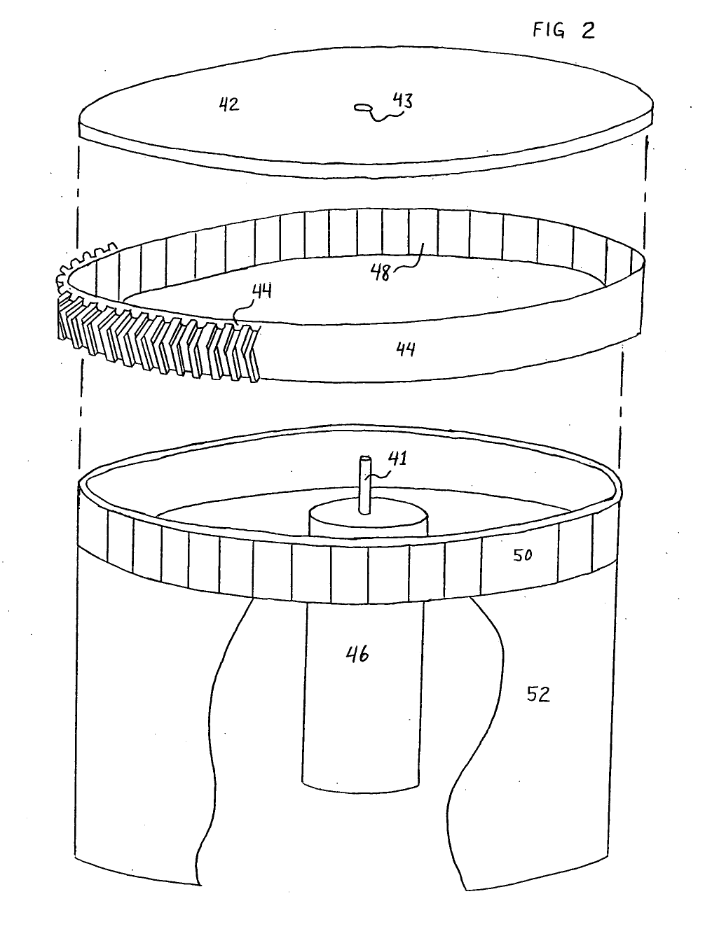

FIG. 2 is the electric motor auxiliary prime mover

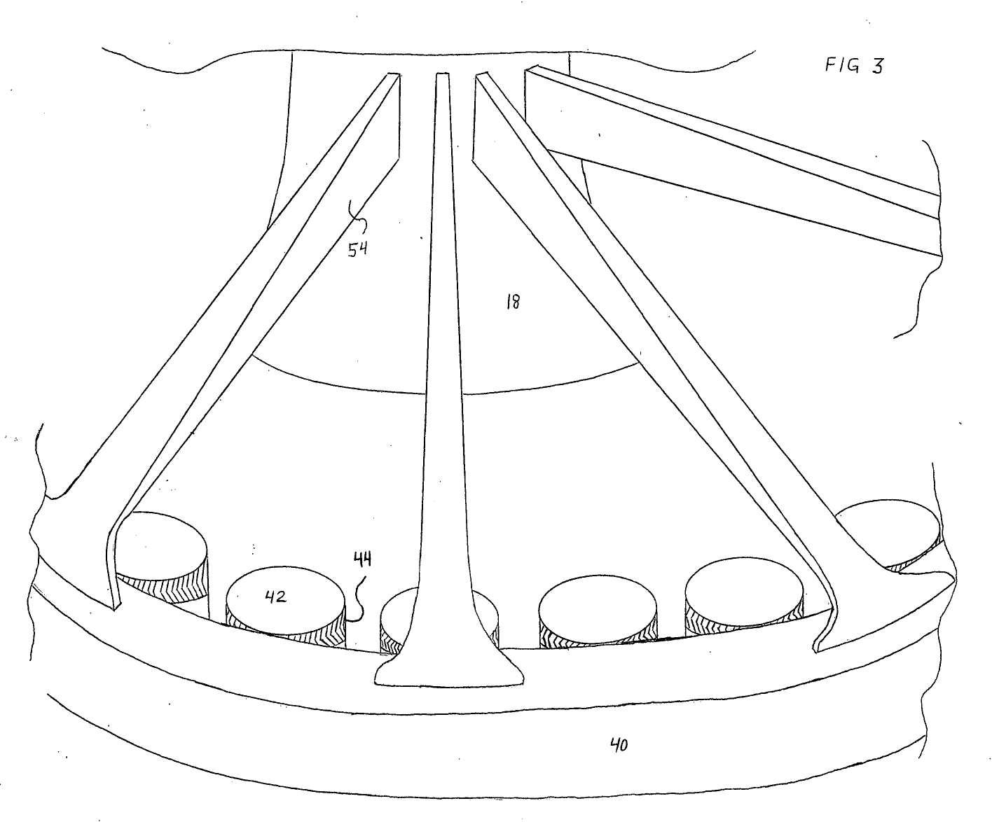

FIG. 3 A close view of the bottom section of a wind turbine, the double tapered spokes, annular generator, and six of the electric motor auxiliary prime movers.

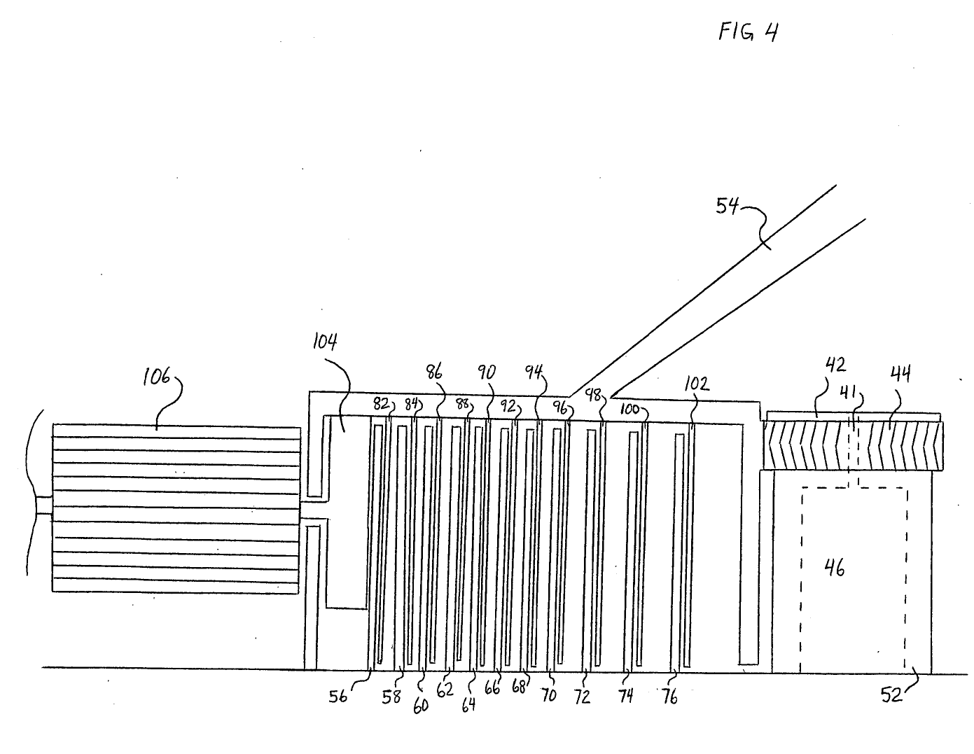

FIG. 4 is a side sectional view of the inside of the big annular generator, and to the right of that is the electric motor auxiliary prime mover.

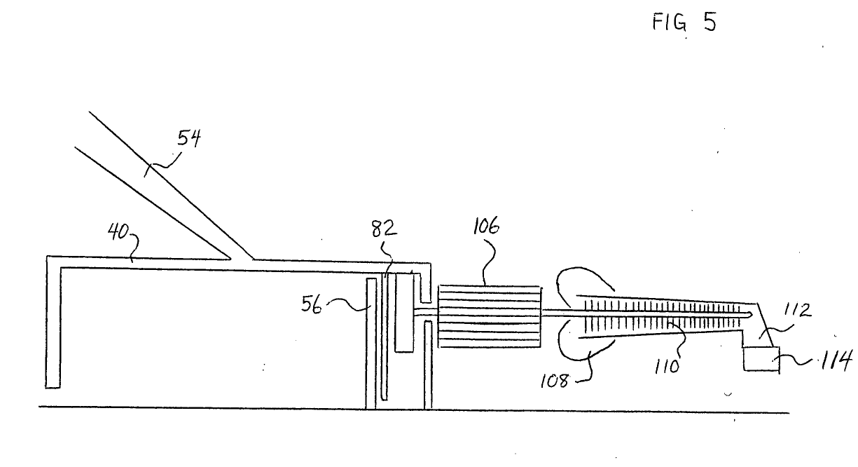

FIG. 5 Big annular generator and steam turbine generator.

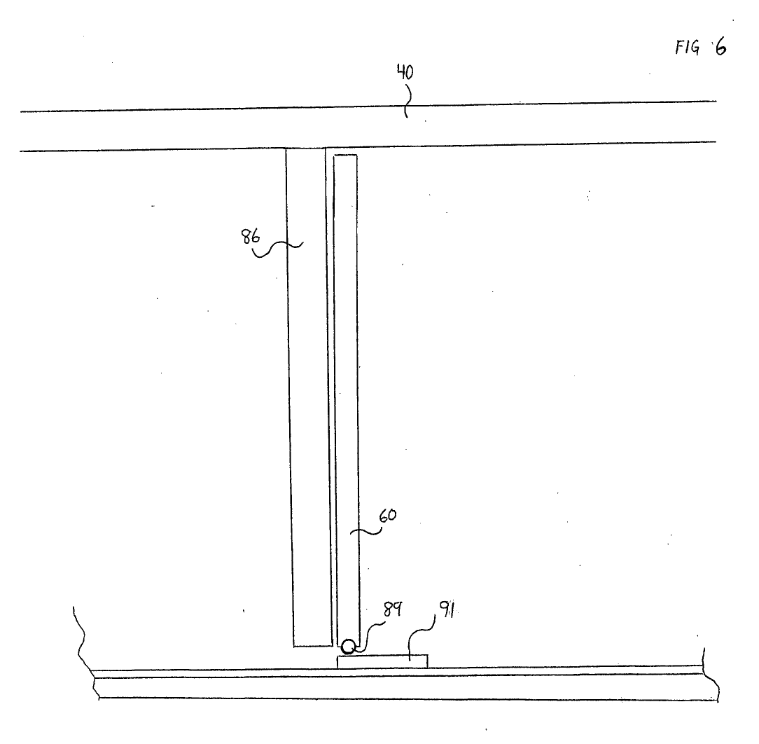

FIG. 6 is a close-up view of the stator-rotor gap distance adjusting mechanism for an annular generator.

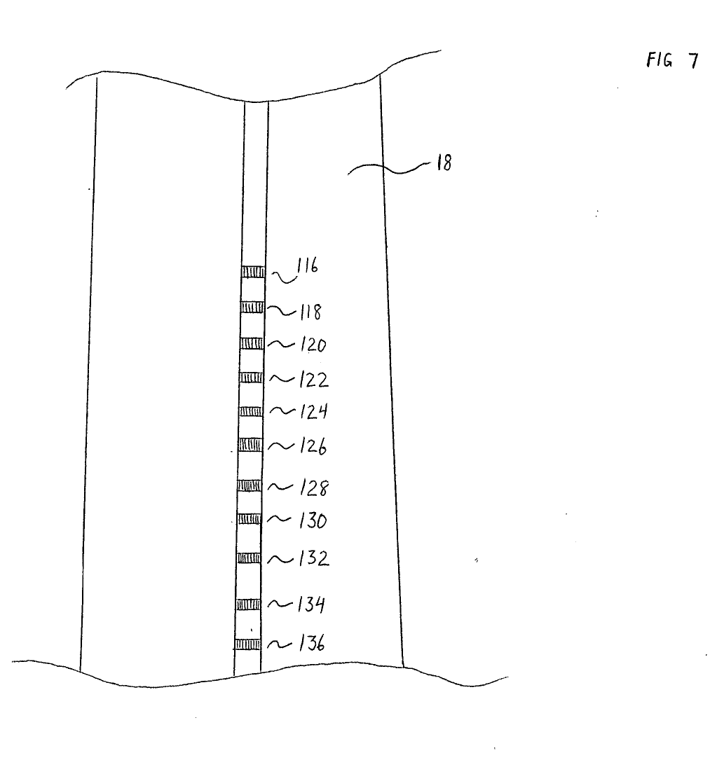

FIG. 7 are the commutators located inside the central axis tower.

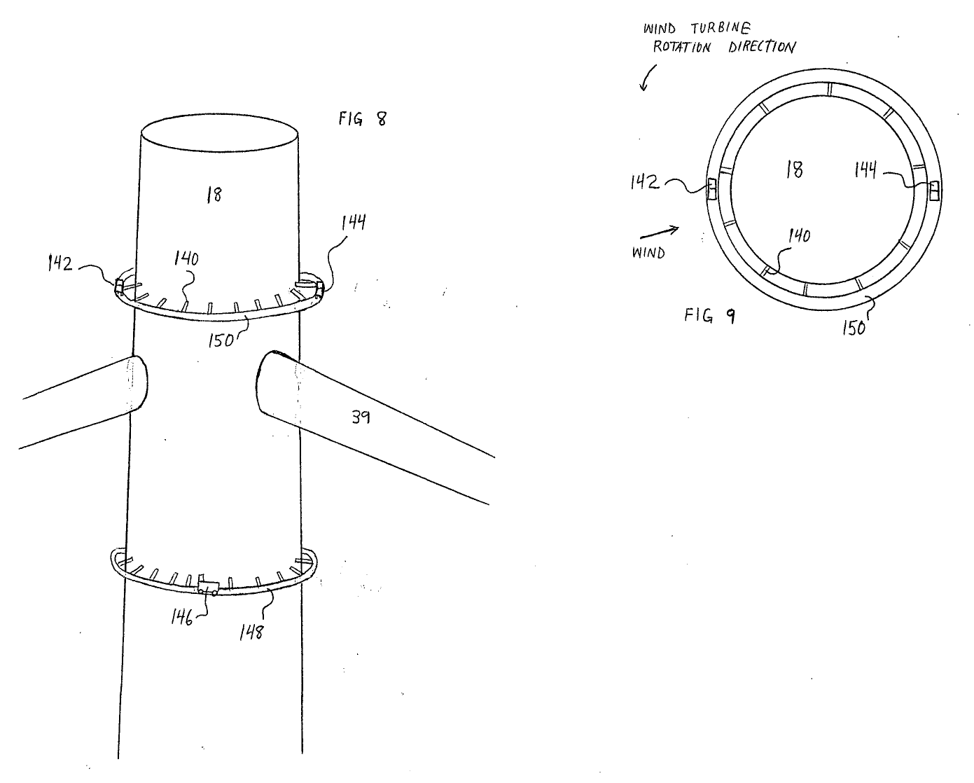

FIG. 8 is the control system that opens and closes the many horizontal axis wind catching panels.

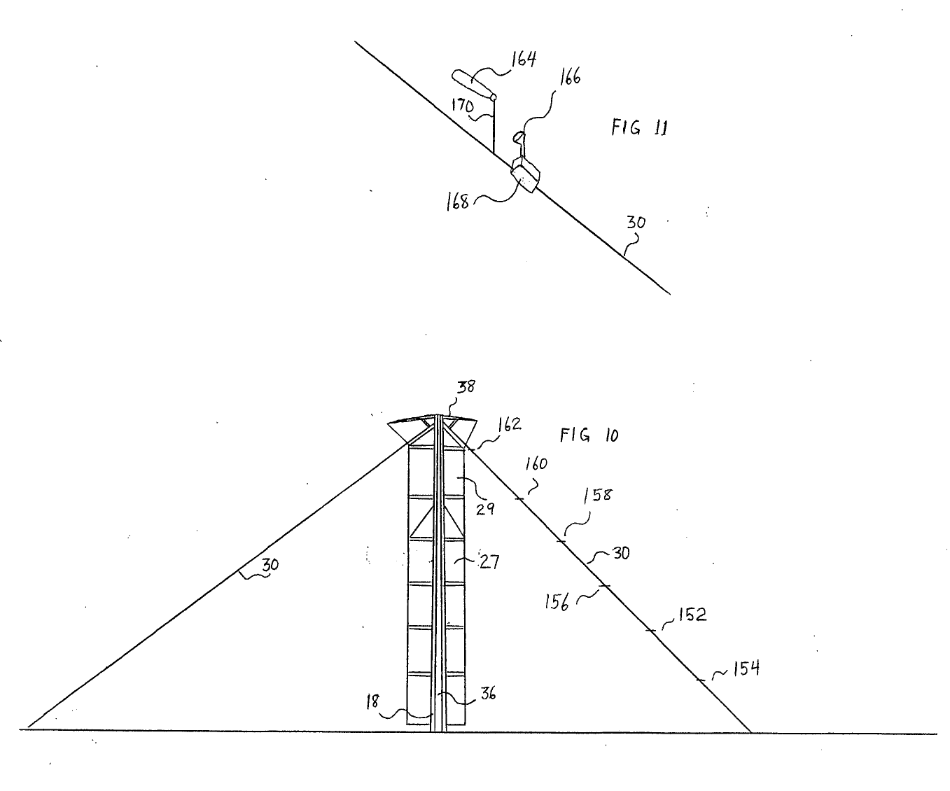

FIG. 9 is a top view of the control system of FIG. 8.

FIG. 10 is a side view of the wind turbine, stays, and also on the stays the wind direction determining device locations are shown.

FIG. 11 is a close-up of one of the wind direction determining devices.

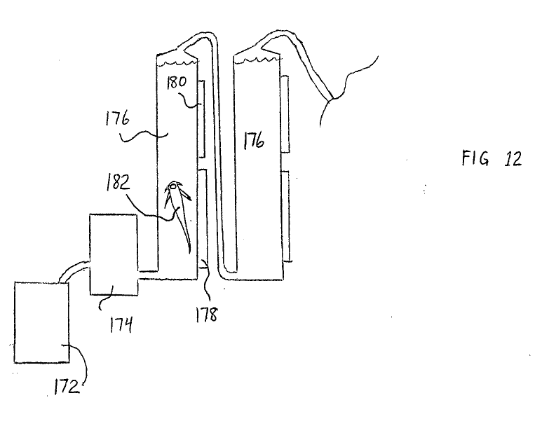

FIG. 12 is the wind turbine pollution mitigation devices.

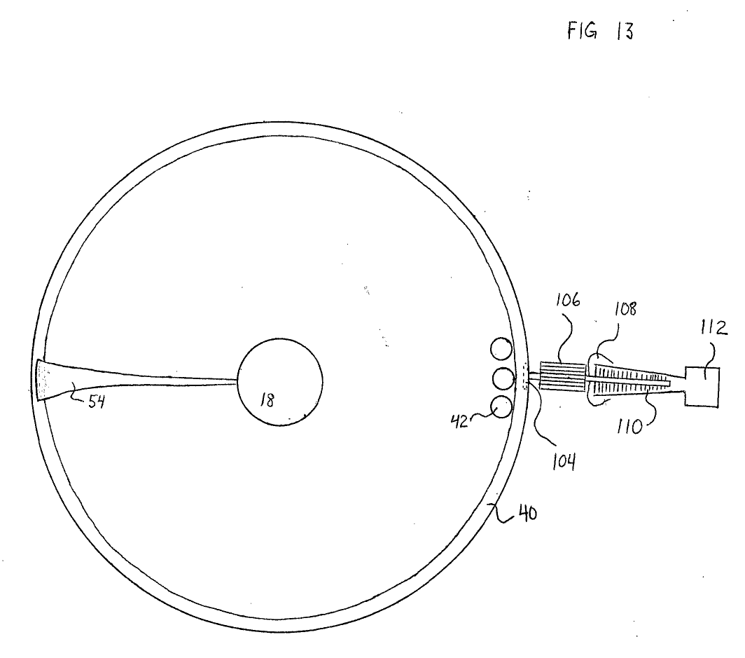

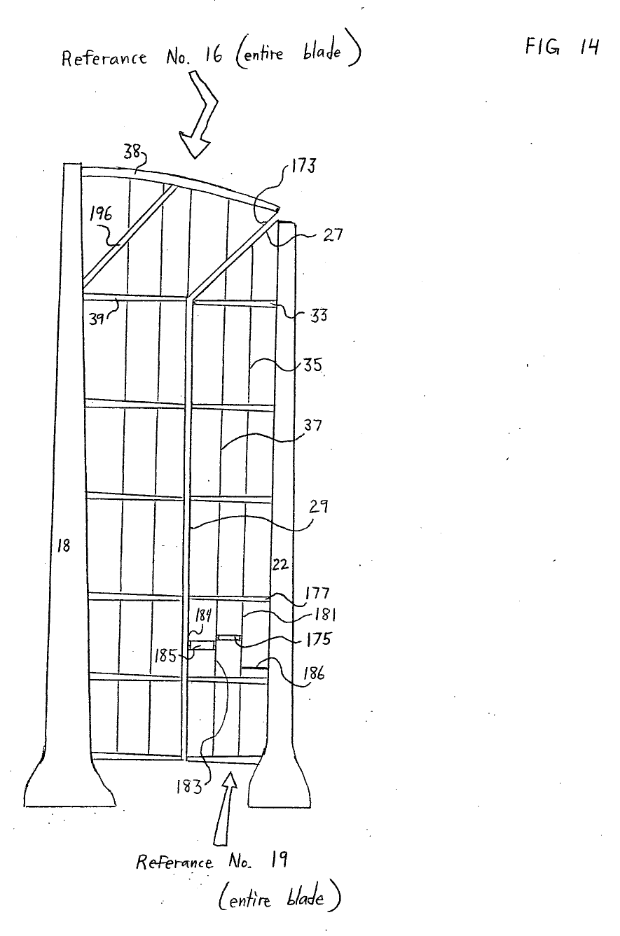

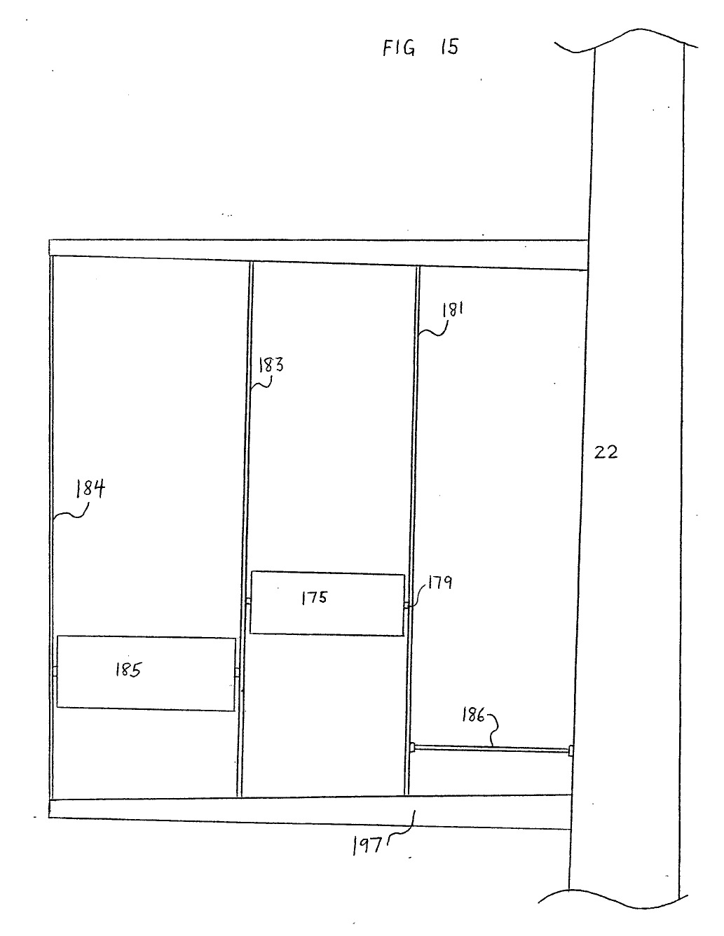

FIG. 13 is a top view of the wind turbine big annular generator with one horizontal steam turbine on the right side.

FIG. 14 A side perspective of 2 blades.

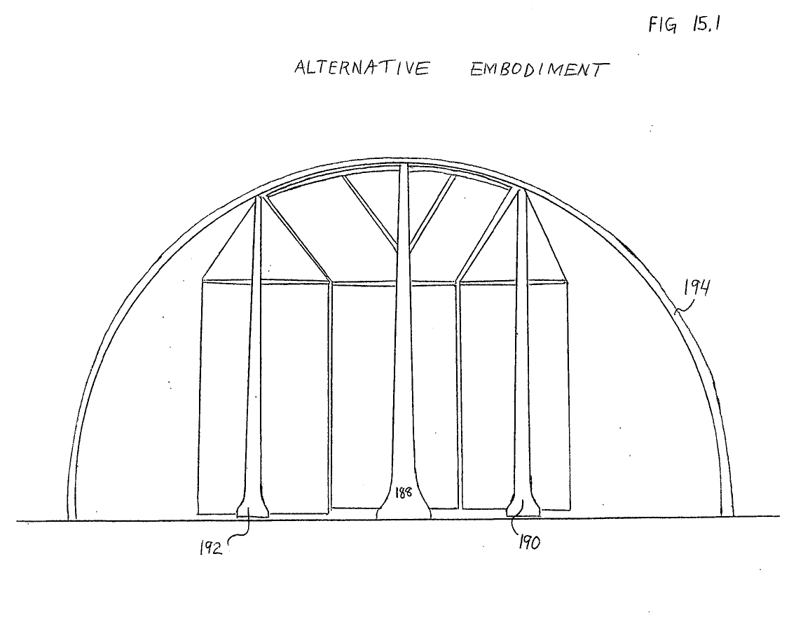

FIG. 15 A close-up view of vanes and wind catching panels.

FIG. 15.1 Alternative Embodiment of the Hybrid Verticle Axis Wind Turbine

### DRAWINGS

### Reference Numerals

16 Blade
17 Blade
18 Central Positioned Central Axis Tower
19 Blade
20 Central Axis Tower
22 Central Axis Tower
24 Central Axis Tower
26 Central Axis Tower
28 Stay
29 Vane Element
30 Stay
32 Stay
33 Arm
34 Stay
35 Vane Element
36 Arch
37 Vane Element
38 Curved Arm
39 Arm
40 Big annular generator
41 Driveshaft
42 Lid
43 Driveshaft Connection Hole
44 Herringbone Gear
46 Small Diameter Electric Motor
48 Auxiliary Annular Generator Rotor
50 Auxiliary Annular Generator Stator
52 Wall
54 Spoke
56 One layer of Big annular generator's Stator
58 One layer of Big annular generator's Stator
60 One layer of Big annular generator's Stator
62 One layer of Big annular generator's Stator
64 One layer of Big annular generator's Stator
66 One layer of Big annular generator's Stator
68 One layer of Big annular generator's Stator
70 One layer of Big annular generator's Stator
72 One layer of Big annular generator's Stator
74 One layer of Big annular generator's Stator
76 One layer of Big annular generator's Stator
82 One layer of Big annular generator's Rotor
84 One layer of Big annular generator's Rotor
86 One layer of Big annular generator's Rotor
88 One layer of Big annular generator's Rotor
89 wheel
90 One layer of Big annular generator's Rotor
91 Stator Track
92 One layer of Big annular generator's Rotor
94 One layer of Big annular generator's Rotor
96 One layer of Big annular generator's Rotor
98 One layer of Big annular generator's Rotor
100 One layer of Big annular generator's Rotor
102 One layer of Big annular generator's Rotor
104 Horizontal Rotating Steam Turbine Gear
106 Horizontal Rotating Steam Turbine Generator
108 Steam Recovery Outlet
110 Turbine
112 Steam Inlet
114 Boiler
116 Commutator
118 Commutator
120 Commutator
122 Commutator
124 Commutator
126 Commutator
128 Commutator
130 Commutator
132 Commutator
134 Commutator
136 Commutator
140 Connecting device from Central Axis Tower to Track
142 Cart (Commanding panels to close)
144 Cart (Commanding panels to open)
146 Cart
148 Track
150 Track
152 second lowest elevation wind direction determining device
154 lowest elevation wind direction determining device
156 third lowest elevation wind direction determining device
158 fourth lowest elevation wind direction determining device
160 second highest elevation wind direction determining device
162 highest elevation wind direction determining device
172 Filtered Exhaust from combustion of fuel of horizontal steam turbine generator
173 Vane Element
174 Urea treatment
176 Clear Algae Tube
177 Arm
179 Electric Motor
180 Artificial Light
188 Central Positioned Central Axis Tower
190 Central Axis Tower
192 Central Axis Tower
181 Vane Element
182 Plecostimus Fish
175 Wind Catching Panel (closed and catching wind)
184 Vane Element
185 Wind Catching Panel (closed and catching wind)
186 Wind Catching Panel (open and not catching wind)
194 Arch
196 diagonal arm
197 Arm

### DETAILED DESCRIPTION

### FIG. 1—Preferred Embodiment

One embodiment of the hybrid vertical axis wind turbine is illustrated in FIG. 1, a perspective view of the entire wind turbine. As wind blows into the blade 16, a plurality of wind catching panels are closed while a plurality of wind catching panels on blade 17 are open (wind catching panels not drawn in FIG. 1 for clarity reasons) simultaneously 2 other prime movers (106, 42) assist propel the wind turbine, allowing the wind turbine to rotate counter clockwise. If a wind at the very top section of the wind turbine is blowing in a different direction than the lower parts, the wind turbine sensors from 162 to 154 detect it and open and close all wind catching panels at the proper time to harness as much wind as possible. Electric motor auxiliary prime movers 42 assist propel the wind turbines big annular generators 40. Horizontal Rotating Steam Turbine Generator 106 and 110 are shown connected to the furthest right positioned wind turbine. The standard 3 blades of the wind turbines are visible in a perspective view on the far left wind turbine containing central axis tower 26. Diagonal Arm 196 is also labeled. FIG. 3 is the bottom part of central axis tower 18, and the spokes 54 that connect the central axis tower to the big annular generator 40 are drawn. The electric motor auxiliary prime movers are also represented by 42. Herringbone Gear 44 is also shown. FIG. 4 is a cutout side perspective of the big annular generator and Electric Motor Auxiliary Prime Mover connected to it by the Herringbone Gear 44. The even numbers 82 to 102 show the rotor sections of the Big annular generator while the stator sections are shown in even numbers 56 to 76. The Small Diameter Electric Motor 46 is shown hidden behind wall 52 of the Electric Motor Auxiliary Prime Mover. Driveshaft 41 is connected to 42 lid, to assist propel gear 44, which in turn assist propels Big annular generator, 40. In conditions of very strong wind, little or no electricity needs to be consumed by Small Diameter Electric Motor 46, and thus a significant advantage of this wind turbine is revealed; a regenerative braking and regenerative propulsion of the wind turbine. This unique feature allows the wind turbine to produce a surprising amount of electricity. FIG. 2 illustrates a perspective exploded view of the Electric Motor Auxiliary Prime Mover 42 lid, small diameter electric motor 46, driveshaft 41 is connected to 42 lid via hole 43, and thus propels gear 44, which is meshed with the auxiliary annular generator rotor 48, which moves past the auxiliary annular generator stator 50, to produce power at all times, whether wind is light or strong. Gear 44 is connected to the big annular generator, thus either assist propels the wind turbine's big annular generator, or regenerative brakes the big annular generator. This prime mover also regenerates power by itself when it is assist propelling the big annular generator. Also, when the wind is very strong, it is possible for no electric power to be taken and consumed from the grid to power small diameter electric motor 46. This Electric Motor Auxiliary Prime Mover's annular generator is drawn with one layer of stator-rotor. FIG. 5 shows how the steam turbine generator 106 and gear 104 are connected to the big annular generator 40. FIG. 6 is a close side view of the stator-rotor gap distance adjusting device 60 stator is moved close to 86 rotor, and moved away from it along track 91, by powered wheel 89. This mechanism is useful to the generator if it is turning too fast and overheating. In such conditions, the gap distance is widened, allowing the generator to continue to produce electricity, by cooling itself down yet not stop rotating. The mechanism is also useful to reduce resistance within the generator at startup, allowing the generator to pick up rotational speed, and once it is established, the gap can narrow, producing more electricity. During wind turbine operation, the layers of stator-rotor may be continuously narrowing and widening to sufficiently cool the generator. FIG. 7 shows commutators where electricity is drawn out of the wind turbine and sent to the outside for conversion and transmission to society. There is one commutator (evens 116 to 136) for each layer of stator-rotor existing on the Big annular generator 40. FIG. 8 and FIG. 9 show the controlling device tracks 148, 150 on the central axis tower 18. It shows the carts 142, 144 that carry the sensors to detect blades passing by, and thus the carts then understand they need to send a command to wind catching panels passing by cart position 142 to close (catch the wind) and to open to a horizontal position at 144 (thus allowing wind to pass through). On FIG. 9, the bird's eye view of FIG. 8, one can see the direction of wind. There are many controllers on a wind turbine of substantial height, and for each pair of cart controllers, there is one wind direction determination device (with a wind sock and camera) accompanied to the same elevation, located on the cable stays shown in FIG. 10 and FIG. 11. FIG. 10 is a side perspective of the entire wind turbine with stays 30 on both sides of the arch 36. 152, 154, 158, 160 and 162 are positions on the stays where wind socks are located. FIG. 11 shows a wind sock 164, a pole 170 holding the wind sock in place, camera 166 and 168 command sending device. The plurality of wind socks and tracks is representative of how many sections on the blades 16 have a dedicated controller. FIG. 12 is the pollution mitigation device attached to this wind turbine, with horizontal rotating steam turbine generator's filtered exhaust 172 being sent to a urea treatment process 174, then into a series of clear tube water tanks 176 that have algae inside of them, so carbon dioxide is consumed and mitigated by algae in the water. Artificial Lights 180 assist in growing algae at dark. Algae will grow into a mess, so plecostimus fish 182 are living in the water to consume some of the algae so it does not grow out of control which would limit the effectiveness of the algae carbon sequestration process. Finally, after going through many tubes, the exhaust gas is emitted into the environment or further sequestered (further sequestration not a part of this application). FIG. 13 is a top view of the annular generator 40, central axis tower 18, spoke 54, Electric Motor Auxiliary Prime Mover 42, gear 104, generator 106, steam turbine 110, boiler 112, and steam return shoot 108. There are 1 to a substantial number of steam turbine generators on the preferred embodiment, and they are positioned around the outside of the Big annular generator, accept in areas where an adjacent wind turbine or arch is located. FIG. 14 is a side view of the central positioned central axis tower 18, and blade 16, and an adjacent tower 22 and blade 19. Also shown are wind catching panels 175 and 185. 175 and 185 are both in the closed (wind catching) position. 186 is also a wind catching panel in an open position, allowing wind to pass through. Vane element 173 connects arm 38 and arm 39. Vane Elements 181 and 183 hold wind catching panel 175 sturdily in place. Vane elements 184 and 183 hold wind catching panel 185 sturdily in place. In all available space on all three blades of each wind turbine, the wind catching panels are attached. FIG. 15 is a close view of a section of blade 19. Motor 179 is shown connected to wind catching panel 175. On one half of a revolution of the wind turbine, wind catching panel 175 is in a 90 degree position, and on the other half of the revolution, the wind catching panel is rotated to a position at 0 degrees, shown in wind catching panel 186 (thickness of wind catching panel 186 may be exaggerated to show substance) FIG. 15.1 is a side perspective of the Alternative Embodiment of the Hybrid Vertical Axis Wind Turbine.

### Advantages

This hybrid vertical axis wind turbine will be able to operate in any wind speed; this overcomes past inferiorities of wind power that produce no electricity when wind is calm; and overcomes another past inferiority of wind turbines having to shut down when the wind is too strong; a vital time in which wind must be harnessed. 2. The wind turbine is scalable to a tall size, and can have an enormous windswept surface area and can convert a large amount of wind to electricity or hydrogen. 3. The wind turbine is using a relatively small amount of land compared to present day wind farms and thus can be located nearly anywhere from Urban to Rural areas, contrary to a perceived need for large spending on new power lines for wind turbines that apparently must be located in rural areas. 4. The wind turbine uses a synergy of at least 2 different types of prime movers to make a surprisingly large amount of electricity. 5. The wind turbine will be constructed close to or exceeding the tallest heights of any structures in history, so it will be able to harness the strongest winds that exist at higher elevations, which is another critical advantage the present wind turbine overcomes where prior art wind turbines struggle. 6. Another problem this wind turbine overcomes is it provides a way for a wind turbine to harness all wind, even wind blowing at different directions at 2 different elevations of the same geographic area; present day horizontal axis propeller type wind turbines cannot harness such wind because their propeller blades would be slowed down by contradictory winds.

Although the description above contains many specificities, these should not be construed as limiting the scope of the embodiment but as merely providing illustrations of some of the presently preferred embodiments. For example the wind turbine could have mini vertical axis wind turbines on the blades instead of or in combination with the wind catching panels, or the arrangements of the gears of the many Electric Motor Auxiliary Prime Movers could be different to maximize efficiency, or the wind turbine stator could be propelled in the opposite direction as the rotor, or the wind turbine gears could be shaped differently, or the stator-rotor gap adjusting device may be changed to a set stationary gap distance, or the arch may need another arch segment at a 90 degree angle to the first arch to be sturdy enough, or a single wind turbine tower under one arch may be more efficient, etc. Thus the scope of the embodiment should be determined by the appended claims and their legal equivalents, rather than by the examples given.

I claim:

1) A hybrid vertical axis wind turbine electric generator comprising (a) a big annular generator (b) one to a substantial number of electric motor auxiliary prime movers; the improvement over prior art being a synergy using wind as a prime mover and electric motor generators meshed with gears that propel and regenerate electricity simultaneously—as an additional prime mover.

2) Said big annular generator in claim 1 comprised of one to a substantial number of layers of stator-rotor.

3) Said big annular generator in claim 1 further comprised of a commutator for each layer of stator rotor on said big annular generator.

4) Said big annular generator in claim 1 further comprised of a during-operation stator-rotor gap distance adjusting mechanism.

5) Said electric motor auxiliary prime mover in claim 1 comprised of an electric motor of small diameter and an auxiliary annular generator of a medium diameter size.

6) Said auxiliary annular generator in claim 5 meshed with a Herringbone Gear of larger diameter size.

7) Said auxiliary annular generator in claim 5 further comprised of one to many layers of stator-rotor.

8) Said big annular generator further comprised of 2 sets of gear teeth.

9) First set of gear teeth in claim 8 to be connected with said electric motor auxiliary prime mover annular generator gear teeth.

10) A horizontal rotating steam turbine generator with a gear.

11) A Second set of gear teeth in claim 8 to be connected with said horizontal rotating steam turbine generator with said gear.

12) One to several said horizontal rotating steam turbine generators in claim 10 connected to big annular generator.

13) Said wind turbine in claim 1 further comprised of a central-positioned central axis tower and at least 2 additional wind turbine central axis towers, each directly adjacent to opposite sides of said central positioned central axis tower.

14) Said wind turbine in claim 1 further including double tapered spokes connecting said central axis tower to said big annular generator.

15) Said central axis towers in claim 13 further comprised of 3 blades, each attached to said central axis tower by one to a substantial number of arms.

16) Said wind turbine in claim 1 further comprised of at least one arch extending over the top of said central axis towers.

17) Three arms in claim 15 more particularly curved exclusively for said central positioned central axis tower; said curved arms longer than remainder of said arms.

18) Said blades in claim 15 comprised of several vertical vane elements attached to said arms.

19) Said vane elements in claim 18 holding a plurality of rectangular shaped horizontal axis, long end positioned horizontally, electric motor controlled wind catching panels.

20) Said arch in claim 16 further comprised of stays attached to each side of said arch, extending to the ground.

21) Said stays in claim 20 to be positioned at a starting point just outside the reach of a circular rotational boundary of said central positioned central axis tower's curved arms; stay positions to be further extending in one to a substantial number of positions along both sides of said arch and down said arch.

22) A wind turbine controlling device of said wind catching panels in claim 19; said controlling device comprised of 2 elements; wind direction determining devices and blade detection devices.

23) Said wind direction determining devices in claim 22 further comprised of a wind sock and a camera located in close proximity to said wind sock.

24) Said controlling device in claim 22 further comprised of a wind turbine blade proximity detection sensor carried by two circular moving carts on a track that further commands a section of said horizontal axis wind catching panels to close at about 5 degrees offset in the clockwise direction from the degree of wind origination, and to open at about 175 degrees offset in the counterclockwise direction from the degree of wind origination.

25) One to a substantial number of clear tube water filled algae carbon dioxide pollution mitigation devices comprising (a) artificial lighting and (b) at least one plecostimus living inside said tubes.

26) A pollution mitigation device in claim 25 further comprised of a urea treatment process that occurs before exhaust enters said algae tubes.
